(19) United States
(12) Patent Application Publication
(10) Pub. No.: US 2025/0016582 A1
(43) Pub. Date: Jan. 9, 2025

(54) METHOD AND APPARATUS FOR CONFIGURING IDENTIFIER OF REMOTE UE AND UE

(71) Applicant: VIVO MOBILE COMMUNICATION CO., LTD., Dongguan (CN)

(72) Inventor: Jinhua LIU, Dongguan (CN)

(73) Assignee: VIVO MOBILE COMMUNICATION CO., LTD., Dongguan (CN)

(21) Appl. No.: 18/892,664

(22) Filed: Sep. 23, 2024

Related U.S. Application Data
(63) Continuation of application No. PCT/CN2023/083613, filed on Mar. 24, 2023.

(30) Foreign Application Priority Data
Mar. 25, 2022 (CN) 202210301818.1

(51) Int. Cl. H04W 24/02; H04W 76/30; H04W 92/18

(52) U.S. Cl. CPC H04W 24/02; H04W 76/30; H04W 92/18

(57) ABSTRACT

This application discloses a method and an apparatus for configuring an identifier of a remote UE and a UE. The method for configuring an identifier of a remote UE includes: determining, by a relay UE, at least one candidate identifier; and configuring, by the relay UE, a first target identifier in the at least one candidate identifier for a first remote UE. The first remote UE is a remote UE that accesses a service of the relay UE.

### CROSS-REFERENCE TO RELATED APPLICATIONS

This application is a continuation of International Application No. PCT/CN2023/083613, filed on Mar. 24, 2023, which claims priority to Chinese Patent Application No. 202210301818.1, filed on Mar. 25, 2022. The entire contents of each of the above-referenced applications are expressly incorporated herein by reference.

### TECHNICAL FIELD

This application pertains to the field of wireless communication technologies, and in particular, to a method and an apparatus for configuring an identifier of a remote UE, and a UE.

### BACKGROUND

When sidelink communication cannot be directly established between two remote User Equipment (UEs) due to poor quality of a sidelink radio channel, one of the remote UEs may find a proper relay UE, and establish a relay channel through the relay UE. Communication between the two remote UEs is implemented through data forwarding by using the relay UE, to implement UE-to-UE (UE to UE, U2U) communication.

In a Layer 2 (L2) relay network, a network device serves as a main control node in a network architecture. An identifier used by the remote UE for relay transmission is configured by the network device. The identifier is carried in a packet header of a data packet, so that the relay UE can identify a data packet that needs to be forwarded to the remote UE, and the network device can identify a data packet from the remote UE.

However, in an L2 U2U relay structure, wireless connections between both the relay UE and the remote UE and the network device may be disconnected, and consequently, the network device cannot configure an identifier for the remote UE.

### SUMMARY

Embodiments of this application provide a method and an apparatus for configuring an identifier of a remote UE and a UE.

According to a first aspect, a method for configuring an identifier of a remote UE is provided, including: determining, by a relay UE, at least one candidate identifier; and configuring, by the relay UE, a first target identifier in the at least one candidate identifier for a first remote UE, where the first remote UE is a remote UE that accesses a service of the relay UE.

According to a second aspect, an apparatus for configuring an identifier of a remote UE is provided, including: a determining module, configured to determine at least one candidate identifier; and a configuration module, configured to configure a first target identifier in the at least one candidate identifier for a first remote UE.

According to a third aspect, a method for selecting an identifier of a remote UE is provided, including: sending, by a first remote UE, first indication information to a relay UE, where the first indication information is used to indicate at least one candidate identifier; receiving, by the first remote UE, a message sent by the relay UE, where the message carries the at least one candidate identifier and tag information, and the tag information is used to indicate whether the at least one candidate identifier is available; and selecting, by the first remote UE, an available first target identifier from the at least one candidate identifier as an identifier of the first remote UE based on the tag information.

According to a fourth aspect, an apparatus for selecting an identifier of a remote UE is provided, including: a sending module, configured to send first indication information to a relay UE, where the first indication information is used to indicate at least one candidate identifier; a receiving module, configured to receive a message sent by the relay UE, where the message carries the at least one candidate identifier and tag information, and the tag information is used to indicate whether the at least one candidate identifier is available; and a selection module, configured to select an available first target identifier from the at least one candidate identifier as an identifier of the first remote UE based on the tag information.

According to a fifth aspect, a UE is provided. The UE includes a processor and a memory, and a program or an instruction that can be run on the processor may be stored in the memory. When the program or the instruction is executed by the processor, the steps of the method according to the first aspect or the steps of the method according to the third aspect are implemented.

According to a sixth aspect, a UE is provided, including a processor and a communication interface. The processor is configured to implement the steps of the method according to the first aspect, or implement the steps of the method according to the third aspect. The communication interface is configured to communicate with an external device.

According to a seventh aspect, a readable storage medium is provided. The readable storage medium stores a program or an instruction. When the program or the instruction is executed by a processor, the steps of the method according to the first aspect or the steps of the method according to the third aspect are implemented.

According to an eighth aspect, a chip is provided. The chip includes a processor and a communication interface, the communication interface is coupled to the processor, and the processor is configured to run a program or an instruction, to implement the steps of the method according to the first aspect or the steps of the method according to the third aspect.

According to a ninth aspect, a computer program product/program product is provided. The computer program product/program product is stored in a storage medium, and the computer program/program product is executed by at least one processor to implement the steps of the method according to the first aspect or the steps of the method according to the third aspect.

In the embodiments of this application, a relay UE determines at least one candidate identifier, and configures a first target identifier in the at least one candidate identifier for a remote UE that accesses the relay UE, so that even if wireless connections between both the relay UE and the remote UE and a network device are disconnected, an identifier can still be configured for the remote UE.

### BRIEF DESCRIPTION OF DRAWINGS

FIG. 1 is a block diagram of a wireless communication system to which embodiments of this application may be applied;

FIG. 2 is a schematic diagram of a U2U network architecture to which embodiments of this application may be applied;

FIG. 3a is a schematic diagram of a user plane protocol stack of layer 2 relay;

FIG. 3b is a schematic diagram of a control plane protocol stack of layer 2 relay;

FIG. 4 is a schematic flowchart of a method for configuring an identifier of a remote UE according to an embodiment of this application;

FIG. 5 is a schematic flowchart of a method for selecting an identifier of a remote UE according to an embodiment of this application;

FIG. 6 is a schematic diagram of a structure of an apparatus for configuring an identifier of a remote UE according to an embodiment of this application;

FIG. 7 is a schematic diagram of a structure of an apparatus for selecting an identifier of a remote UE according to an embodiment of this application;

FIG. 8 is a schematic diagram of a structure of a communication device according to an embodiment of this application; and

FIG. 9 is a schematic diagram of a hardware structure of a UE according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the term NR is used in most of the following description, although these technologies can also be applied to applications other than the NR system application, such as the 6^{th} Generation (6G) communication system.

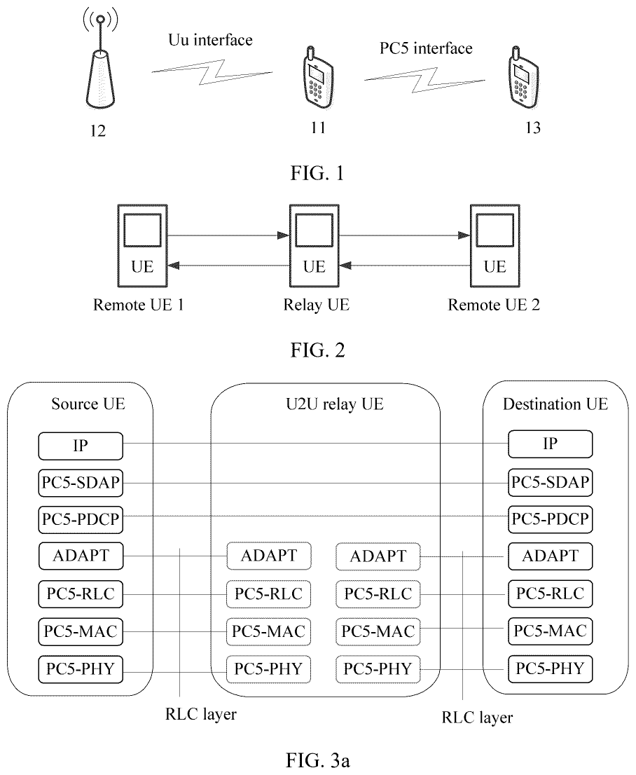

FIG. 1 is a block diagram of a wireless communication system to which embodiments of this application may be applied. The wireless communication system includes a relay UE 11, a network side device 12, and a remote UE 13. In this embodiment of this application, the remote UE 13 communicates with the relay UE 11 by using a PC5 (sidelink or relay link) interface, and the relay UE 11 communicates with the network side device 12 by using a Uu interface.

The relay UE 11 may also be referred to as a relay UE device or relayUE. The remote UE 13 may also be referred to as a remote UE device or a remote UE. The relay UE 11 and the remote UE 13 may be UE side devices, for example, mobile phones, tablet personal computers, laptop computers which are alternatively referred to as notebook computers, Personal Digital Assistant (PDA), palmtop computers, netbooks, Ultra-Mobile Personal Computers (UMPC), Mobile Internet devices (MID), wearable devices, or Vehicle User Equipment (VUE), and Pedestrian User Equipment (PUE). Wearable devices include bracelets, earphones, glasses, and the like. It should be noted that a specific type of the relay UE 11 and a specific type of the remote UE 13 are not limited in the embodiments of this application. The network side device 12 may be a network device or a core network. The network device may be referred to as a Node B, an evolved Node B, an access point, a Base Transceiver Station (BTS), a radio base station, a radio transceiver, a Basic Service Set (BSS), an Extended Service Set (ESS), a Node B, an evolved Node B (eNB), a home Node B, a home evolved Node B, a Wireless Local Area Network (WLAN) access point, a Wireless Fidelity (WiFi) node, a Transmitting Receiving Point (TRP), or another specific appropriate term in the art. The network device is not limited to a specific technical vocabulary provided that a same technical effect is achieved. It should be noted that in the embodiments of this application, a network device in the NR system is merely used as an example, but a specific type of the network device is not limited.

FIG. 2 is a schematic diagram of a U2U network architecture to which embodiments of this application may be applied. As shown in FIG. 2, when sidelink communication cannot be directly established between a remote UE 1 and a remote UE 2 due to poor quality of a sidelink radio channel, the remote UE 1 or the remote UE 2 may find a proper relay UE and establish a relay channel through the relay UE. Communication between the remote UE 1 and the remote UE 2 is implemented by the relay UE by forwarding data.

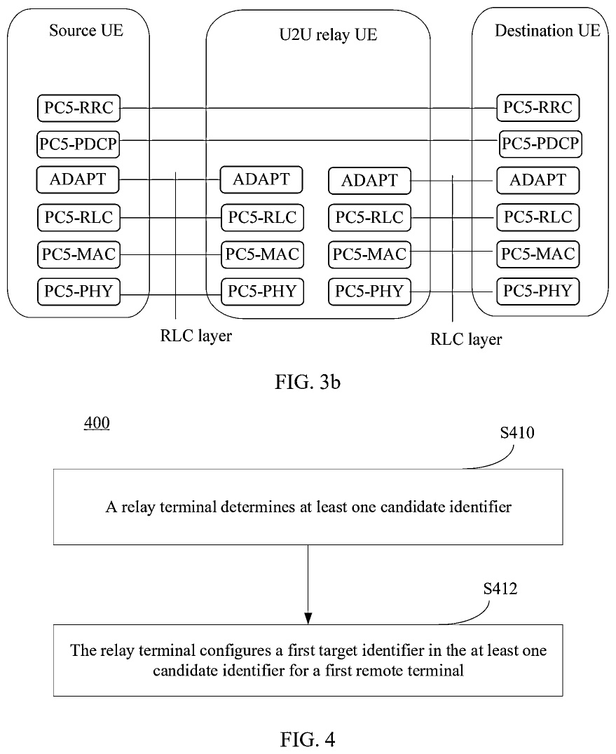

In a related technology, a user plane protocol stack and a control plane protocol stack of layer 2 relay may be shown in FIG. 3a and FIG. 3b, respectively. A Sidelink Relay Adaptation Protocol (SRAP) has a function of routing and identifying a forwarded data packet, and a protocol header of the relay adaptation layer may include:
an identifier of a source remote UE and/or a destination remote UE in a case that a data packet is forwarded between two remote UEs;
a sidelink radio bearer identifier between the source remote UE and the destination remote UE; and
identification information of a routing function of a relay channel, for example, an identifier of the relay channel.

Based on the user plane protocol framework, after receiving a to-be-forwarded Packet Data Convergence Protocol (PDCP) Protocol Data Unit (PDU), an SRAP layer protocol entity of a remote UE determines an identifier or an address of a destination remote UE, generates an SRAP layer protocol header, and adds the SRAP layer protocol header before the PDCP PDU to form an SRAP PDU. After receiving the SRAP PDU, a relay UE determines the destination remote UE based on SRAP packet header information of the SRAP PDU, and forwards the SRAP PDU to the destination remote UE.

Based on the control plane protocol framework, Radio Resource Control (RRC) information and data between the two remote UEs use a relay transmission method similar to that in the SRAP protocol. An RRC message may be identified and corresponding processing may be performed by receiving a ratio bearer indication carried in an SRAP packet header carried in the SRAP PDU.

A solution for configuring an identifier of a remote UE provided in the embodiments of this application is described in detail below with reference to the accompanying drawings by using specific embodiments and application scenarios thereof.

FIG. 4 is a schematic flowchart of a method for configuring an identifier of a remote UE according to an embodiment of this application. The method 400 may be performed by a relay UE. In other words, the method may be performed by software or hardware installed in the relay UE. As shown in FIG. 4, the method may include the following steps:
S410: A relay UE determines at least one candidate identifier.
S412: The relay UE configures a first target identifier in the at least one candidate identifier for a first remote UE, where the first remote UE is a remote UE that accesses a service of the relay UE.

In this embodiment of this application, an identifier of the remote UE may also be referred to as an SRAP address of the remote UE, an SRAP identifier, a local identifier of the remote UE, a U2U network address of the remote UE, and the like.

In this embodiment of this application, the relay UE configures the first target identifier to the first remote UE; in other words, the relay UE establishes a binding relationship between the first target identifier and the first remote UE. The first remote UE may be identified by using the first target identifier.

In the technical solution provided in this embodiment of this application, the relay UE determines the at least one candidate identifier, and configures the first target identifier in the at least one candidate identifier to the remote UE that accesses the relay UE, so that even if wireless connections between both the relay UE and the remote UE and a network device are disconnected, an identifier can still be configured for the remote UE. Further, the first remote UE may obtain an identifier that is used to address the first remote UE in an L2 U2U network, and reduce a probability that identifier collision occurs between different remote UEs in the U2U network.

In this embodiment of this application, the relay UE may determine the at least one candidate identifier based on a configuration or a pre-configuration of the network device, an indication of the first remote UE, and the like. Therefore, in a possible implementation, S410 may include at least one of the following (1) to (3).

The relay UE obtains a first target configuration parameter from the network device (for example, a base station), and obtains the at least one candidate identifier based on the first target configuration parameter, where the first target configuration parameter is used to configure a first value field of a candidate identifier allocable by the relay UE, and the first value field includes an identifier full-value field or a subfield of an identifier full-value field.

For example, a serving network device of the relay UE may configure a list or range of available identifiers for the relay UE, and the relay UE configures an identifier for the remote UE within the list or range. For example, it is assumed that the identifier full-value field is [0, 255],and in this case, the serving network device of the relay UE may configure the first target configuration parameter. The first target configuration parameter configures a first value field for candidate identification that can be configured by the relay UE as [0, 100], or the first target configuration parameter configures a first value field for candidate identification that can be configured by the relay UE as [0, 255], or the first target configuration parameter configures a first value field for candidate identification that can be configured for the relay UE as a list, for example, {0, 2, 4, 6, 8, 10}.

In specific application, the relay UE may be a relay UE in a plurality of remote UE pairs. For example, the relay UE may be used as a relay UE between a remote UE 1 and a remote UE 2, and may be also used as a relay UE between a remote UE 3 and a remote UE 4. Therefore, an identifier may need to be configured for each remote UE in the plurality of remote UE pairs. In a case that there are a relatively large quantity of the plurality of remote UE pairs, all candidate identifiers configured by the first target configuration parameter may be configured or may be inadequate. To enable the relay UE to continue to configure an identifier for each accessed remote UE, in a possible implementation, after the relay UE obtains the first target configuration parameter from the network device, the method further includes: In a case that candidate identifiers obtained based on the first target configuration parameter have been exhausted or a proportion of used candidate identifiers obtained based on the first target configuration parameter exceeds a predetermined threshold, the relay UE requests the network device to configure more available candidate identifiers. For example, identifies pre-configured by the serving network device to the relay UE have been exhausted or a use proportion exceeds a predetermined threshold, the relay UE may request the network device to configure more available candidate identifiers.

In a possible implementation, to enable the network device to learn a configuration status of candidate identifiers configured for the relay UE, after the relay UE obtains the first target configuration parameter from the network device, the method further includes: The relay UE sends configuration information to the network device, where the configuration information includes at least one of the following: a quantity of used candidate identifiers obtained based on the first target configuration parameter, a quantity of unused candidate identifiers obtained based on the first target configuration parameter, a proportion of used candidate identifiers obtained based on the first target configuration parameter, and a proportion of unused candidate identifiers obtained based on the first target configuration parameter. For example, the relay UE may report a proportion or a quantity of pre-configured identifiers, a quantity of unconfigured identifiers, a proportion of identifiers pre-configured by the network device, and the like to the network device.

In the foregoing implementation, the relay UE may actively send the configuration information, or may send the configuration information at the request of the network device, so that the network device learns that a status of configuring the candidate identifiers. Therefore, in a possible implementation, before the relay UE sends the configuration information for the network device, the method further includes: The relay UE receives a first request sent by the network device, where the first request is used to request the relay UE to report the configuration information; and
the relay UE obtains the at least one candidate identifier based on a pre-configured second target configuration parameter.

In this possible implementation, the second target configuration parameter may be pre-configured in the relay UE, and the relay UE obtains the at least one candidate identifier based on the second target configuration parameter. For example, the second target configuration parameter may configure a full-value field (for example, 0-255) of allocable candidate identifiers, or may configure a plurality of available sub-fields (for example, a sub-field list). The relay UE determines that the at least one candidate identifier is all identifiers in the full-value field, or the relay UE determines that the at least one candidate identifier is one sub-field in the full-value field, or is one sub-field in the plurality of configured sub-field lists. Alternatively, the second target configuration parameter may directly configure a sub-field (for example, 0-100), and the relay UE determines that the at least one candidate identifier is an identifier in the sub-field.

When determining, based on the second target configuration parameter, that the at least one candidate identifier is a sub-field of the allocable candidate identifiers, a sub-field may be randomly selected from the sub-field list or determined based on a pre-configured rule, for example, selected based on a mapping relationship between a specific identifier of the relay UE and a sub-field. For example, the sub-field is selected based on a mapping relationship between a cell radio network temporary identifier (Cell RNTI, C-RNTI) or an inactive RNTI (Inactive RNTI, I-RNTI) of the relay UE and a sub-field. For example, a mod (C-RNTI, quantity of sub-fields) th sub-field is selected from the sub-field list.

In this embodiment of this application, the network device may explicitly or implicitly enable the relay UE to autonomously determine the at least one candidate identifier. Therefore, in a possible implementation, before the relay UE determines the at least one candidate identifier based on the pre-configured second target configuration parameter, the method further includes: The relay UE receives second indication information sent by the network device, where the second indication information indicates that the relay UE is allowed to configure an identifier for the remote UE.

In a possible implementation, that the relay UE receives the second indication information sent by the network device may include one of the following:
the relay UE receives a system message broadcast by the network device, where the system message carries the second indication information;
for example, the network device may enable, by using the system message, the relay UE to autonomously configure an identifier for the remote UE, where for example, the network device may add an indication field to a System Information Block (SIB) 12 to indicate whether the relay UE can autonomously configure an identifier for the remote UE; or
the relay UE receives UE-specific signaling sent by the network device, where the UE-specific signaling carries the second indication information, where for example, the network device may indicate, by using Non-Access Stratum (NAS) signaling, whether the relay UE can autonomously configure an identifier for the remote UE.

In a possible implementation, that the relay UE configures a first target identifier in the at least one candidate identifier for the first remote UE may include: The relay UE selects, from the at least one candidate identifier obtained based on the first target configuration parameter, an unused candidate identifier as the first target identifier, and configures the first target identifier for the first remote UE.

In some embodiments, in a case that the relay UE is within coverage of a cell and obtains the first target configuration parameter from the network device, the relay UE selects an unused candidate identifier (that is, an identifier that is not configured by the relay UE for another remote UE) from the at least one candidate identifier as the first target identifier and configures the first target identifier to the first remote UE.

In some embodiments, in a case that the relay UE is within coverage of a cell and does not obtain the first target configuration parameter from the network device, the relay UE may send a second request to the network device, where the second request is used to request the network device to provide the first target configuration parameter for the relay UE; and then the relay UE receives the first target configuration parameter configured by the network device.

For example, when the relay UE is within coverage of a cell, the relay UE configures an identifier to the remote UE based on a remote identifier configuration (that is, the foregoing first target configuration parameter) provided by the network device. If the relay UE is within coverage of a cell but the cell does not provide an identifier configuration of the remote UE, the relay UE may request the cell to provide the identifier configuration of the remote UE. In some embodiments, the cell is a cell that supports configuring a remote UE identifier configuration for the relay UE.

In a possible implementation, that the relay UE configures a first target identifier in the at least one candidate identifier for the first remote UE may include: The relay UE selects, from the at least one candidate identifier obtained based on the second target configuration parameter, an unused candidate identifier as the first target identifier, and configures the first target identifier for the first remote UE.

In some embodiments, in a case that the relay UE is outside coverage of a cell, the relay UE may select an unused candidate identifier from the at least one candidate identifier as the first target identifier and configure the first target identifier for the first remote UE.

In some embodiments, the relay UE may configure the first target identifier for the first remote UE in a discovery procedure, for example, configuration is performed in the discovery procedure. After receiving a discovery message that the first remote UE requests to forward, the relay UE adds an identifier configured for the remote UE to a response message of discovery information that is subsequently sent to the remote UE.

Alternatively, after receiving a discovery message of the first remote UE, the relay UE configures the first target identifier for the first remote UE, adds the first target identifier to the discovery message, and then forwards the discovery message that carries the first target identifier. After receiving the discovery message that carries the first target identifier, a communication peer end of the first remote UE, that is, the second remote UE, adds the first target identifier to a response discovery message of discovery information that is subsequently sent to the remote UE. After receiving the response discovery message, the relay UE forwards the response discovery message to the first remote UE, so that the first remote UE may learn that the identifier configured by the relay UE for the first remote UE.

Alternatively, the relay UE may directly indicate the first target identifier to the first remote UE. For example, the relay UE may send the first target identifier to the first remote UE by using a sidelink radio resource control (PC5 RRC) signaling procedure. For example, in a process of establishing a relay sidelink between the first remote UE and the relay UE, the relay UE configures an identifier of the first remote UE by using PC5 RRC signaling.

The relay UE receives first indication information sent by the first remote UE, and obtains the at least one candidate identifier based on the first indication information, where the first indication information is used to indicate at least one identifier.

In this possible implementation, the first remote UE may autonomously and randomly determine several candidate identifiers, and when initiating a relay channel establishment request, the first remote UE generates one or more candidate identifiers that can be used by the first remote UE, and sends the first indication information to the relay UE, where the indication information is used to indicate the several candidate identifiers determined by the first remote UE. The relay UE determines the at least one candidate identifier based on the first indication information.

For example, the relay UE may use one or more identifiers indicated by the first indication information as the at least one candidate identifier, or the relay UE may send one or more identifiers indicated by the first indication information to a second remote UE (that is, a communication peer end of the first remote UE). The second remote UE may determine whether the one or more identifiers indicated by the first indication information include an identifier of the second remote UE. If yes, an indication is sent to the relay UE, and after removing the identifier of the second remote UE in the one or more identifiers indicated by the first indication information, the relay UE determines that remaining one or more identifiers are the at least one candidate identifier.

In a possible implementation, the relay UE may store identifier occupation information, and record, in the identifier occupation information, an identifier that has been used by the relay UE, for example, an identifier that has been configured by the relay UE for the remote UE. In S412, the relay UE may select, based on the stored identifier occupation information from the at least one candidate identifier obtained based on the first indication information, an unused candidate identifier as the first target identifier, and configures the first target identifier for the first remote UE.

In a possible implementation, the relay UE may further configure the first target identifier for the first remote UE together with the first remote UE. Therefore, in this possible implementation, the selecting an unused candidate identifier from the at least one candidate identifier as the first target identifier and configuring the first target identifier for the first remote UE may include the following steps:
Step 1: The relay UE marks an unused identifier in the at least one candidate identifier based on the identifier occupation information, and/or identifies a used identifier in the at least one candidate identifier based on the identifier occupation information.
Step 2: The relay UE sends the identified at least one candidate identifier to the first remote UE.
Step 3: The relay UE receives a notification sent by the first remote UE, where the notification carries the first target identifier selected by the first remote UE.
Step 4: The relay UE determines to configure the first target identifier for the first remote UE.

In this possible implementation, the relay UE may mark an available identifier or an occupied identifier in the candidate identifier based on the identifier occupation information obtained by the relay UE, and send this message to the first remote UE; and the first remote UE determines the first target identifier to be used by the first remote UE, and reports the first target identifier to the relay UE. In some embodiments, the relay UE may implement the foregoing steps in the discovery procedure of the first remote UE or in a sidelink radio resource control (PC5-RRC) procedure.

In one or more possible implementations, after the relay UE configures the first target identifier in the at least one candidate identifier for the first remote UE, the method may further include the following steps:
Step 1: The relay UE records the first target identifier in the identifier occupation information, where the identifier occupation information is used to record an identifier that has been used by the relay UE.
Step 2: The relay UE deletes the first target identifier in the at least one candidate identifier.

For example, the relay UE may maintain a remote UE identifier list, and store a list of occupied or configured identifiers and a list of allocable identifiers, and the relay UE lists, in the list of occupied identifiers, an identifier that has been configured for the remote UE, and lists an unconfigured or released identifier in the list of allocable identifiers.

In actual application, after the relay UE configures the first target identifier for the first remote UE, the relay UE may further release the first target identifier, to increase utilization of the identifier. Therefore, in a possible implementation, after the relay UE configures the first target identifier in the at least one candidate identifier for the first remote UE, the method may further include:
in a predetermined condition, the relay UE releases the first target identifier, for example, the relay UE may delete a binding relationship between the first target identifier and the first remote UE, that is, the first target identifier is unbound from the first remote UE; and
the relay UE re-lists the released first target identifier as the candidate identifier. For example, the first target identifier is added to the list of allocable identifiers.

In some embodiments, the predetermined condition includes but is not limited to one of the following:
after the relay UE releases a relay sidelink to the first remote UE, for example, after releasing the relay sidelink to the remote UE, the relay UE may determine to release the identifier of the remote UE;
after the relay UE receives a relay sidelink release request from the first remote UE, for example, after receiving a relay sidelink release request sent by the remote UE, the relay UE determines to release the relay sidelink, and therefore, the identifier of the remote UE may be released; and
after a relay sidelink connection failure occurs between the relay UE and the first remote UE, for example, after a relay sidelink connection failure occurs on the remote UE after an identifier is configured for the remote UE, the relay UE may determine to release the identifier of the remote UE.

After the relay UE notifies the first remote UE that a target event occurs, where the target event includes one of the following: a radio link failure occurs on a link between the relay UE and the network device, and a handover failure occurs on the link between the relay UE and the network device. For example, after notifying the UE that a Radio Link Failure (RLF) or a handover failure occurs on a Uu link between the relay UE and the serving network device, the relay UE may determine to withdraw the identifier.

The relay UE determines that the first remote UE does not use the first target identifier within preset time. For example, when determining that a relay UE does not use a specific identifier within a preset period of time, the relay UE may autonomously release the identifier.

The relay UE reconfigures an identifier different from the first target identifier for the first remote UE. For example, after the relay UE configures the first target identifier for the first remote UE, and for some reason, configures a new identifier for the remote UE, the relay UE may determine to release the first target identifier that is previously configured.

In a possible implementation, that the relay UE releases the first target identifier may include: The relay UE sends a notification to the first remote UE, to indicate the first remote UE to release the first target identifier. For example, the relay UE may notify a remote UE by using PC5-RRC signaling to release an identifier that has been configured.

In a possible implementation, that the relay UE releases the first target identifier may further include: The relay UE deletes the first target identifier from identifier occupation information, where the identifier occupation information is used to record an identifier that has been used by the relay UE; and the relay UE adds the first target identifier to the at least one candidate identifier. For example, the first target identifier is deleted from the list of occupied or configured identifiers, and the first target identifier is added to the list of allocable identifiers.

In a possible implementation, that the relay UE configures the first target identifier in the at least one candidate identifier for the first remote UE includes the following steps:
Step 1: The relay UE receives a message from the first remote UE, where the message requests an identifier configured by the relay UE for the first remote UE.

The message may explicitly request the identifier configured by the relay UE to the first remote UE. For example, request information is carried in a message, and the request information is used to request the identifier configured by the relay UE for the first remote identifier. Alternatively, the message may implicitly request the identifier configured by the relay UE for the first remote UE. For example, if the remote UE does not add the identifier to a relay message forwarded by the relay UE, the relay UE may configure the identifier for the remote UE.
Step 2: The relay UE configures the first target identifier in the at least one candidate identifier for the first remote UE.

In some embodiments, after the relay UE configures the first target identifier in the at least one candidate identifier for the first remote UE, after adding the first target identifier to the message, the relay UE forwards the message that carries the first target identifier. For example, the relay UE adds the identifier configured for the remote UE to a forwarded discovery signal, and then forwards the discovery signal.

In a possible implementation, the method may further include the following steps:
Step 1: In a relay connection establishment process initiated by the first remote UE, the relay UE receives a second target identifier reported by the first remote UE, where the second target identifier is an identifier that is configured by the relay UE for the first remote UE before receiving the relay connection establishment request.
Step 2: The relay UE confirms, to the first remote UE, that the first remote UE continues to use the second target identifier, or the relay UE re-configures the first target identifier for the first remote UE.

In this possible implementation, in a case that the first remote UE already has the second target identifier configured by the relay UE, the first remote UE may report to the relay UE in a process of initiating a relay connection establishment request, and the relay UE may confirm to the first remote UE that the second target identifier is to be continued to be used, or may re-configure the first target identifier for the first remote UE, so that the first remote UE and the relay UE may have consistent understanding.

In some embodiments, the first remote UE may report the second target identifier by using a discovery message, or may report the second target identifier by using PC5 RRC signaling. Therefore, that the relay UE receives the second target identifier reported by the first remote UE may include:
the relay UE receives a discovery message sent by the first remote UE, where the discovery message carries the second target identifier; or
the relay UE receives sidelink radio resource control signaling sent by the first remote UE, where the sidelink radio resource control signaling carries the second target identifier.

In a possible implementation, after the relay UE receives the discovery message sent by the first remote UE, the method further includes: After adding the identifier of the first remote UE (for example, the second target identifier or the first target identifier) to the discovery message, the relay UE forwards the discovery message that carries the identifier of the first remote UE.

For example, when a remote UE initiates a relay connection establishment request by using the relay UE, the remote UE may already have an identifier previously configured by the relay UE. In this case, to avoid a case that one remote UE occupies a plurality of identifiers, the remote UE may report a configured identifier for the relay UE, and the relay UE may confirm that the remote UE reuses an existing identifier, or may configure a new identifier for the UE. The identifier may be carried in a discovery signal, or the relay UE may be notified by using subsequent PC5-RRC signaling. In some embodiments, when the identifier may be carried in a discovery signal, the relay UE also forwards the identifier when forwarding the discovery signal to the remote UE.

In some embodiments, when the remote UE has previously obtained an identifier from one relay UE, and first pre-configured time elapses after the identifier is obtained last time or second pre-configured time elapses after the identifier is used last time, it is determined that the identifier expires. When initiating the relay channel establishment request, the remote UE does not report the identifier or needs to re-apply for the identifier.

In one or more possible implementations, after the relay UE configures the first target identifier in the at least one candidate identifier for the first remote UE, the method may further include: The relay UE notifies a second remote UE of the first target identifier configured for the first remote UE, where the second remote UE is a communication peer end of the first remote UE.

For example, the relay UE may add the first target identifier to a discovery message sent by the first remote UE, and notify the second remote UE of the first target identifier.

In a possible implementation, the method may further include: The relay UE notifies the first remote UE of a third target identifier configured for the second remote UE. For example, after forwarding the discovery message to the second remote UE, the relay UE receives a response discovery message sent by the second remote UE; and if the response discovery message does not carry an identifier of the second remote UE, the relay UE may configure the third target identifier for the second remote UE, and add the third target identifier to the response discovery message sent to the first remote UE.

In this embodiment of this application, if the remote UE supports a function of a sidelink relay adaptation layer, the remote UE may generate an SRAP PDU, that is, the remote UE adds an SRAP packet header before the PDCP PDU, where the SRAP packet header includes routing information, including an identifier of the SRAP packet header, an identifier of a peer-end remote UE, a radio bearer identifier, and the like. The remote UE is required in this method.

Alternatively, after receiving a PDCP PDU from a remote UE (a remote UE 1), the relay UE may add an SRAP packet header to the PDCP PDU, where the SRAP packet header includes routing information, including an identifier of the remote UE (that is, the remote UE 1), an identifier of a peer-end remote UE (that is, a remote UE 2), a radio bearer identifier, and the like. After receiving an SRAP PDU of the peer-end remote UE (that is, the remote UE 2), the relay UE determines, based on an SRAP packet header of the SRAP PDU, whether a destination remote UE of the SRAP PDU is the remote UE (that is, the remote UE 1). If yes, the relay UE removes the SRAP packet header of the SRAP PDU, and sends the obtained PDCP PDU to the remote UE (that is, the remote UE 1). In this manner, the remote UE 1 may not support the function of the sidelink relay adaptation layer.

According to the technical solution provided in this embodiment of this application, the remote UE may obtain an identifier that is used to address the remote UE in an L2 U2U network, and reduce a probability that an identifier collision occurs between different remote UEs in the U2U network.

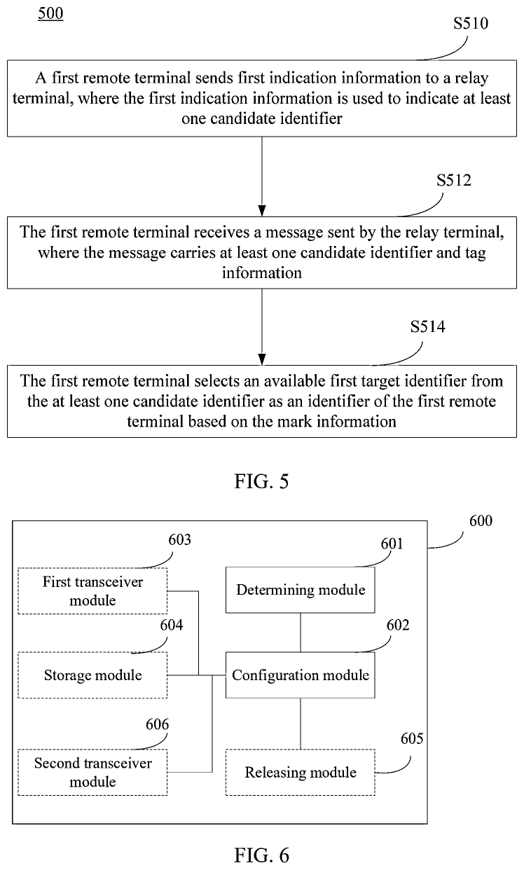

FIG. 5 is a schematic flowchart of a method for selecting an identifier of a remote UE according to an embodiment of this application. The method 500 may be performed by a first remote UE. In other words, the method may be performed by software or hardware installed in the first remote UE. As shown in FIG. 5, the method may include the following steps:
S510: The first remote UE sends first indication information to a relay UE, where the first indication information is used to indicate at least one candidate identifier.

For example, the first remote UE may send a discovery message to the relay UE, where the discovery message carries the first indication information.
S512: The first remote UE receives a message sent by the relay UE, where the message carries at least one candidate identifier and tag information, and the tag information is used to indicate whether the at least one candidate identifier is available.

For example, after receiving a response discovery message corresponding to the discovery message, the relay UE may forward, to the first remote UE, a response discovery message that carries the at least one candidate identifier and the tag information.
S514: The first remote UE selects an available first target identifier from the at least one candidate identifier as an identifier of the first remote UE based on the tag information.

In a possible implementation, to enable the relay UE to learn the identifier selected by the first remote UE so as to prevent the relay UE from configuring the identifier for another remote UE, after the selecting an available first target identifier from the at least one candidate identifier as an identifier of the first remote UE, the method may further include: The first remote UE sends a notification to the relay UE, where the notification carries the first target identifier selected by the first remote UE.

The method for configuring an identifier of a remote UE provided in this embodiment of this application may be performed by an apparatus for configuring an identifier of a remote UE. An apparatus for configuring an identifier of a remote UE provided in the embodiments of this application is described by using an example in which the apparatus for configuring an identifier of a remote UE performs the method for configuring an identifier of a remote UE in the embodiments of this application.

FIG. 6 is a schematic diagram of a structure of an apparatus for configuring an identifier of a remote UE according to an embodiment of this application. As shown in FIG. 6, the apparatus 600 mainly includes a determining module 601 and a configuration module 602.

In this embodiment of this application, the determining module 601 is configured to determine at least one candidate identifier, and the configuration module 602 is configured to configure a first target identifier in the at least one candidate identifier for a first remote UE.

In a possible implementation, the determining module 601 is configured to:
obtain a first target configuration parameter from a network device, and obtains the at least one candidate identifier based on the first target configuration parameter, where the first target configuration parameter is used to configure a first value field of a candidate identifier allocable by the relay UE, and the first value field includes an identifier full-value field or a subfield of an identifier full-value field;
obtain the at least one candidate identifier based on a pre-configured second target configuration parameter; and
receive first indication information sent by the first remote UE, and obtain the at least one candidate identifier based on the first indication information, where the first indication information is used to indicate at least one identifier.

In a possible implementation, as shown in FIG. 6, the apparatus may further include:
a first transceiver module 603, configured to: in a case that candidate identifiers obtained based on the first target configuration parameter have been exhausted or a proportion of used candidate identifiers obtained based on the first target configuration parameter exceeds a predetermined threshold, request the network device to configure more available candidate identifiers; and/or
a first transceiver module 603, configured to send configuration information to the network device, where the configuration information includes at least one of the following: a quantity of used candidate identifiers obtained based on the first target configuration parameter, a quantity of unused candidate identifiers obtained based on the first target configuration parameter, a proportion of used candidate identifiers obtained based on the first target configuration parameter, and a proportion of unused candidate identifiers obtained based on the first target configuration parameter.

In a possible implementation, the first transceiver module 603 is further configured to receive a first request sent by the network device, where the first request is used to request the relay UE to report the configuration information.

In a possible implementation, the determining module 601 is further configured to receive second indication information sent by the network device, where the second indication information indicates that the relay UE is allowed to configure an identifier for the remote UE.

In a possible implementation, that the determining module 601 receives the second indication information sent by the network device includes:
receive a system message broadcast by the network device, where the system message carries the second indication information; or
receive UE-specific signaling sent by the network device, where the UE-specific signaling carries the second indication information.

In a possible implementation, that the configuration module 602 configures a first target identifier in the at least one candidate identifier for the first remote UE includes: selecting, from the at least one candidate identifier obtained based on the first target configuration parameter, an unused candidate identifier as the first target identifier, and configuring the first target identifier for the first remote UE.

In a possible implementation, that the configuration module 602 selects an unused candidate identifier from the at least one candidate identifier as the first target identifier, and configures the first target identifier for the first remote UE includes:
in a case that the relay UE is within coverage of a cell and the relay UE obtains the first target configuration parameter from the network device, the relay UE selects an unused candidate identifier from the at least one first candidate identifier as the first target identifier, and configures the first target identifier for the first remote UE.

In a possible implementation, the configuration module 602 is further configured to:
in a case that the relay UE is within coverage of a cell and the relay UE does not obtain the first target configuration parameter from the network device, send a second request to the network device, where the second request is used to request the network device to provide the first target configuration parameter for the relay UE; and
receive the first target configuration parameter configured by the network device.

In a possible implementation, that the configuration module 602 configures a first target identifier in the at least one candidate identifier for the first remote UE includes: selecting, from the at least one candidate identifier obtained based on the second target configuration parameter, an unused candidate identifier as the first target identifier, and configuring the first target identifier for the first remote UE.

In a possible implementation, that the configuration module 602 selects an unused candidate identifier from the at least one candidate identifier as the first target identifier and configures the first target identifier for the first remote UE includes:
in a case that the relay UE is outside coverage of a cell, the relay UE selects an unused candidate identifier from the at least one candidate identifier as the first target identifier, and configures the first target identifier for the first remote UE.

In a possible implementation, that the configuration module configures the first target identifier in the at least one candidate identifier for the first remote UE includes:
the relay UE selects, based on stored identifier occupation information from the at least one candidate identifier obtained based on the first indication information, an unused candidate identifier as the first target identifier, and configures the first target identifier for the first remote UE.

In a possible implementation, that the configuration module 602 selects an unused candidate identifier from the at least one candidate identifier as the first target identifier and configures the first target identifier for the first remote UE includes:
marking an unused identifier in the at least one candidate identifier based on the identifier occupation information, and/or identifying a used identifier in the at least one candidate identifier based on the identifier occupation information;
sending the identified at least one candidate identifier to the first remote UE;
receiving a notification sent by the first remote UE, where the notification carries the first target identifier selected by the first remote UE; and
determining to configure the first target identifier for the first remote UE.

In a possible implementation, as shown in FIG. 6, the apparatus may further include a storage module 604, configured to: record the first target identifier in the identifier occupation information, where the identifier occupation information is used to record an identifier that has been used by the relay UE; and delete the first target identifier from the at least one candidate identifier.

In a possible implementation, as shown in FIG. 6, the apparatus further includes a releasing module 605, configured to: in a predetermined condition, release the first target identifier, and re-list the released first target identifier as a candidate identifier.

In a possible implementation, the predetermined condition includes at least one of the following:
after a relay sidelink to the first remote UE is released;
after a relay sidelink release request from the first remote UE is received;
after a relay sidelink connection failure occurs for the first remote UE;
after the first remote UE is notified of occurrence of a target event, where the target event includes one of the following: a radio link failure occurs on a link to the network device, and a handover failure occurs on the link to the network device;
it is determined that the first target identifier is not used within preset time; and
an identifier different from the first target identifier is reconfigured for the first remote UE.

In a possible implementation, that the releasing module 605 releases the first target identifier includes: sending a notification to the first remote UE, to indicate the first remote UE to release the first target identifier.

In a possible implementation, that the releasing module 605 releases the first target identifier further includes:
deleting the first target identifier from the identifier occupation information, where the identifier occupation information is used to record an identifier that has been used by the relay UE; and
adding the first target identifier to the at least one candidate identifier.

In a possible implementation, that the configuration module 602 configures the first target identifier in the at least one candidate identifier for the first remote UE includes:
receiving a message from the first remote UE, where the message requests an identifier configured by the relay UE for the first remote UE; and
configuring a first target identifier in the at least one candidate identifier for the first remote UE.

In a possible implementation, the configuration module 602 is further configured to: after the relay UE adds the first target identifier to the message, forward the message that carries the first target identifier.

In a possible implementation, as shown in FIG. 6, the apparatus may further include:
a second transceiver module 606, configured to: in a relay connection establishment process initiated by the first remote UE, receive a second target identifier reported by the first remote UE, where the second target identifier is an identifier that is configured by the relay UE for the first remote UE before receiving the relay connection establishment request.

The configuration module 602 is further configured to: confirm, to the first remote UE, that the first remote UE continues to use the second target identifier, or re-configure the first target identifier for the first remote UE.

In a possible implementation, that the second transceiver module 606 receives the second target identifier reported by the first remote UE includes:
receiving a discovery message sent by the first remote UE, where the discovery message carries the second target identifier; or
receiving sidelink radio resource control signaling sent by the first remote UE, where the sidelink radio resource control signaling carries the second target identifier.

In a possible implementation, the second transceiver module 606 is further configured to: after an identifier of the first remote UE is added to the discovery message, forward the discovery message that carries the identifier of the first remote UE.

In a possible implementation, the configuration module 602 is further configured to notify a second remote UE of the first target identifier configured for the first remote UE, where the second remote UE is a communication peer end of the first remote UE.

In a possible implementation, the configuration module 602 is further configured to notify the first remote UE of a third target identifier configured for the second remote UE.

The apparatus for configuring an identifier of a remote UE in the embodiments of this application may be an electronic device, for example, an electronic device with an operating system, or may be a component in the electronic device, for example, an integrated circuit or a chip. The electronic device may be a UE, or another device other than the UE. For example, the UE may include but is not limited to the foregoing listed types of the relay UE 11. Another device may be a server, a NAS, or the like. This is not specifically limited in this embodiment of this application.

The apparatus for configuring an identifier of a remote UE provided in this embodiment of this application can implement the processes implemented by the relay UE in the method embodiment in FIG. 4, and a same technical effect is achieved. To avoid repetition, details are not described herein again.

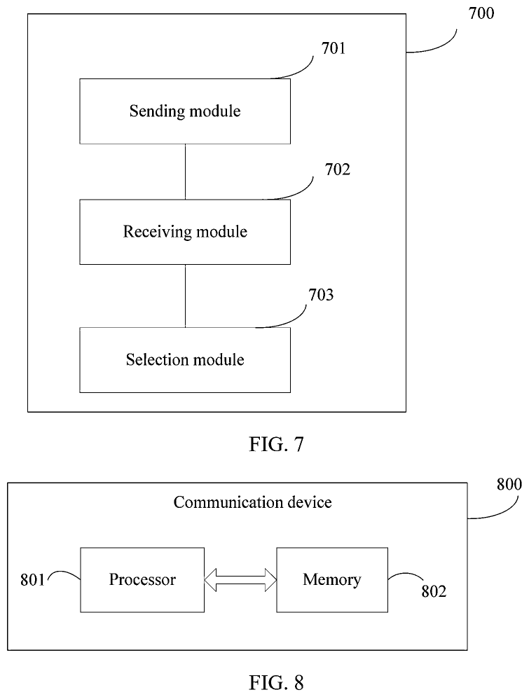

FIG. 7 is a schematic diagram of a structure of an apparatus for selecting an identifier of a remote UE according to an embodiment of this application. As shown in FIG. 7, the apparatus 700 mainly includes a sending module 701, a receiving module 702, and a selection module 703.

In an implementation of this application, the sending module 701 is configured to send first indication information to a relay UE, where the first indication information is used to indicate at least one candidate identifier; the receiving module 702 is configured to receive a message sent by the relay UE, where the message carries at least one candidate identifier and tag information, and the tag information is used to indicate whether the at least one candidate identifier is available; and the selection module 703 is configured to select an available first target identifier from the at least one candidate identifier as an identifier of the first remote UE based on the tag information.

The apparatus for selecting an identifier of a remote UE in this embodiment of this application may be an electronic device, for example, an electronic device with an operating system, or may be a component in the electronic device, for example, an integrated circuit or a chip. The electronic device may be a UE, or another device other than the UE. For example, the UE may include but is not limited to the foregoing listed types of the remote UEs 12. Another device may be a server, a NAS, or the like. This is not specifically limited in the embodiments of this application.

The apparatus for configuring an identifier of a remote UE provided in the embodiments of this application can implement the processes implemented by the first remote UE in the method embodiment in FIG. 5, and a same technical effect is achieved. To avoid repetition, details are not described herein again.

In some embodiments, as shown in FIG. 8, an embodiment of this application further provides a communication device 800, including a processor 801 and a memory 802, and the memory 802 stores a program or an instruction that can be run on the processor 801. For example, in a case that the communication device 800 is a relay UE, when the program or the instruction is executed by the processor 801, the steps in the foregoing embodiments of the method for configuring an identifier of a remote UE, and a same technical effect can be achieved. To avoid repetition, details are not described herein again.

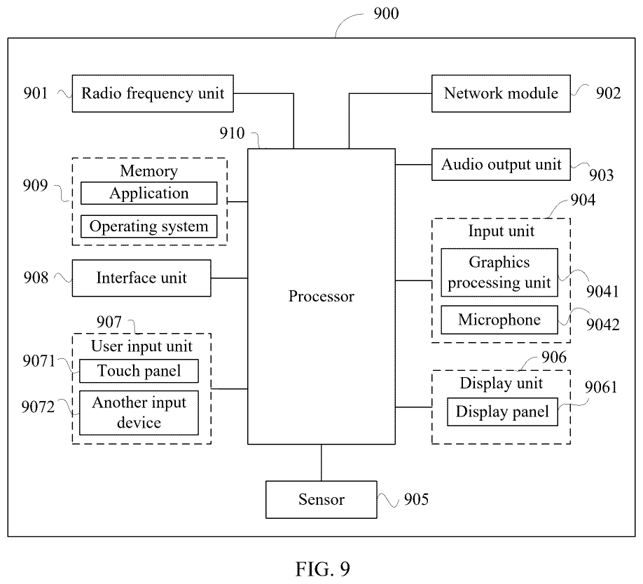

An embodiment of this application further provides a UE, including a processor and a communication interface. The processor is configured to implement the steps in the foregoing embodiment of the method for configuring an identifier of a remote UE, or implement the steps in the foregoing embodiment of the method for selecting an identifier of a remote UE. The communication interface is configured to communicate with an external device. This UE embodiment is corresponding to the foregoing method embodiment on the relay UE side or the foregoing method embodiment on the first remote UE side. Each implementation process and implementation of the foregoing method embodiment may be applicable to this UE embodiment, and a same technical effect can be achieved. Specifically, FIG. 9 is a schematic diagram of a hardware structure of a UE according to an embodiment of this application.

The UE 900 includes but is not limited to components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the UE 900 may further include a power supply (such as a battery) that supplies power to each component. The power supply may be logically connected to the processor 910 by using a power supply management system, to implement functions such as charging and discharging management, and power consumption management by using the power supply management system. The UE structure shown in FIG. 9 constitutes no limitation on the UE, and the UE may include more or fewer components than those shown in the figure, or combine some components, or have different component arrangements. Details are not described herein.

It should be understood that in this embodiment of this application, the input unit 904 may include a Graphics Processing Unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, the radio frequency unit 901 receives downlink data from a network side device and then sends the downlink data to the processor 910 for processing; and sends uplink data to the network side device. Usually, the radio frequency unit 901 includes but is not limited to an antenna, at least one amplifier, a transceiver, a coupler, a low noise amplifier, a duplexer, and the like.

The memory 909 may be configured to store a software program or an instruction and various data. The memory 909 may mainly include a program or instruction storage area and a data storage area. The program or instruction storage area may store an operating system, an application or an instruction required by at least one function (for example, a sound playing function or an image playing function), and the like. In addition, the memory 909 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-volatile solid-state storage device.

The processor 910 may include one or more processing units. In some embodiments, an application processor and a modem processor may be integrated into the processor 910. The application processor mainly processes an operating system, a user interface, an application, an instruction, or the like. The modem processor mainly processes wireless communication, for example, a baseband processor. It may be understood that, in some embodiments, the modem processor may not be integrated into the processor 910.

The processor 910 is configured to: determine at least one candidate identifier; and configure a first target identifier in the at least one candidate identifier for a first remote UE.

Alternatively, the radio frequency unit 901 is configured to: send first indication information to a relay UE, where the first indication information is used to indicate at least one candidate identifier; and receive a message sent by the relay UE, where the message carries the at least one candidate identifier and tag information, and the tag information is used to indicate whether the at least one candidate identifier is available. The processor 910 is configured to select an available first target identifier from the at least one candidate identifier as an identifier of the first remote UE based on the tag information.

An embodiment of this application further provides a readable storage medium. The readable storage medium stores a program or an instruction, and when the program or the instruction is executed by a processor, the processes of the foregoing embodiment of the method for configuring an identifier of a remote UE are implemented, and a same technical effect can be achieved. To avoid repetition, details are not described herein again.

The processor is a processor in the UE in the foregoing embodiments. The readable storage medium includes a computer-readable storage medium, such as a computer read-only memory ROM, a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the method for configuring an identifier of a remote UE, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the foregoing embodiment of the method for configuring an identifier of a remote UE, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a UE (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A method for configuring an identifier of a remote User Equipment (UE), comprising:
determining, by a relay UE, at least one candidate identifier; and
configuring, by the relay UE, a first target identifier in the at least one candidate identifier for a first remote UE,
wherein the first remote UE is a remote UE that accesses a service of the relay UE.

2. The method according to claim 1, wherein the determining, by the relay UE, the at least one candidate identifier comprises at least one of the following:
obtaining, by the relay UE, a first target configuration parameter from a network device, and obtaining the at least one candidate identifier based on the first target configuration parameter, wherein the first target configuration parameter is used to configure a first value field of a candidate identifier allocable by the relay UE, and the first value field comprises an identifier full-value field or a subfield of the identifier full-value field;
obtaining, by the relay UE, the at least one candidate identifier based on a pre-configured second target configuration parameter; or
receiving, by the relay UE, first indication information sent by the first remote UE, and obtaining the at least one candidate identifier based on the first indication information, wherein the first indication information is used to indicate at least one identifier.

3. The method according to claim 2, wherein after the obtaining, by the relay UE, the first target configuration parameter from the network device, the method further comprises:
when candidate identifiers obtained based on the first target configuration parameter have been exhausted or a proportion of used candidate identifiers obtained based on the first target configuration parameter exceeds a predetermined threshold, requesting, by the relay UE, the network device to configure more available candidate identifiers; or
sending, by the relay UE, configuration information to the network device, wherein the configuration information comprises at least one of the following: a quantity of used candidate identifiers obtained based on the first target configuration parameter, a quantity of unused candidate identifiers obtained based on the first target configuration parameter, a proportion of used candidate identifiers obtained based on the first target configuration parameter, or a proportion of unused candidate identifiers obtained based on the first target configuration parameter.

4. The method according to claim 3, wherein before the sending, by the relay UE, the configuration information to the network device, the method further comprises:
receiving, by the relay UE, a first request sent by the network device, wherein the first request is used to request the relay UE to report the configuration information.

5. The method according to claim 2, wherein before the obtaining, by the relay UE, the at least one candidate identifier based on the pre-configured second target configuration parameter, the method further comprises:
receiving, by the relay UE, second indication information sent by the network device, wherein the second indication information indicates that the relay UE is allowed to configure an identifier to the remote UE.

6. The method according to claim 2, wherein the configuring, by the relay UE, the first target identifier in the at least one candidate identifier for the first remote UE comprises:
selecting, by the relay UE from the at least one candidate identifier obtained based on the second target configuration parameter, an unused candidate identifier as the first target identifier, and configuring the first target identifier for the first remote UE.

7. The method according to claim 6, wherein the selecting, by the relay UE from the at least one candidate identifier, the unused candidate identifier as the first target identifier, and configuring the first target identifier for the first remote UE comprises:
when the relay UE is outside coverage of a cell, selecting, by the relay UE, an unused candidate identifier from the at least one candidate identifier as the first target identifier, and configuring the first target identifier for the first remote UE.

8. The method according to claim 2, wherein the configuring, by the relay UE, the first target identifier in the at least one candidate identifier for the first remote UE comprises:
selecting, by the relay UE based on stored identifier occupation information from the at least one candidate identifier obtained based on the first indication information, an unused candidate identifier as the first target identifier, and configuring the first target identifier to the first remote UE.

9. The method according to claim 8, wherein the selecting the unused candidate identifier from the at least one candidate identifier as the first target identifier, and configuring the first target identifier for the first remote UE comprises:
marking, by the relay UE, an unused identifier in the at least one candidate identifier based on the identifier occupation information, or identifying a used identifier in the at least one candidate identifier based on the identifier occupation information;
sending, by the relay UE, the identified at least one candidate identifier to the first remote UE;
receiving, by the relay UE, a notification sent by the first remote UE, wherein the notification carries the first target identifier selected by the first remote UE; and
determining, by the relay UE, to configure the first target identifier for the first remote UE.

10. The method according to claim 1, wherein after the configuring, by the relay UE, the first target identifier in the at least one candidate identifier for the first remote UE, the method further comprises:
recording, by the relay UE, the first target identifier in the identifier occupation information, wherein the identifier occupation information is used to record an identifier that has been used by the relay UE; and
deleting, by the relay UE, the first target identifier in the at least one candidate identifier.

11. The method according to claim 10, wherein after the configuring, by the relay UE, the first target identifier in the at least one candidate identifier for the first remote UE, the method further comprises:
releasing, by the relay UE, the first target identifier in a predetermined condition; and
re-listing, by the relay UE, the released first target identifier as the candidate identifier.

12. The method according to claim 11, wherein the releasing, by the relay UE, the first target identifier comprises:
sending, by the relay UE, a notification to the first remote UE, to indicate the first remote UE to release the first target identifier.

13. The method according to claim 1, wherein the configuring, by the relay UE, the first target identifier in the at least one candidate identifier for the first remote UE comprises:
receiving, by the relay UE, a message from the first remote UE, wherein the message requests an identifier configured by the relay UE for the first remote UE; and
configuring, by the relay UE, the first target identifier in the at least one candidate identifier for the first remote UE.

14. The method according to claim 1, wherein after the configuring, by the relay UE, the first target identifier in the at least one candidate identifier for the first remote UE, the method further comprises:
notifying, by the relay UE, a second remote UE of the first target identifier configured for the first remote UE, wherein the second remote UE is a communication peer end of the first remote UE.

15. The method according to claim 14, wherein the method further comprises:
notifying, by the relay UE, the first remote UE of a third target identifier configured for the second remote UE.

16. A method for configuring an identifier of a remote UE, comprising:
generating, by a first remote UE, a Packet Data Convergence Protocol (PDCP) Protocol Data Unit (PDU),
wherein a packet header of the Sidelink Relay Adaptation Protocol (SRAP) comprises an identifier for a first remote UE and an identifier for a second remote UE, the identifier for the first remote UE is configured by a relay UE, and the second remote UE is a communication peer end of the first remote UE.

17. The method according to claim 16, further comprising:
receiving, by the first remote UE, the identifier for the first remote UE and the identifier for the second remote UE from the relay UE.

18. The method according to claim 16, wherein the identifier for the first remote UE or the identifier for the second remote UE is a local identifier.

19. A UE, comprising a processor and a memory storing instructions, wherein the instructions, when executed by the processor, cause the processor to perform operations comprising:
determining at least one candidate identifier; and
configuring a first target identifier in the at least one candidate identifier for a first remote UE,
wherein the first remote UE is a remote UE that accesses a service of the relay UE.

20. The UE according to claim 19, wherein the determining at least one candidate identifier comprises at least one of the following:
obtaining, by the relay UE, a first target configuration parameter from a network device, and obtaining the at least one candidate identifier based on the first target configuration parameter, wherein the first target configuration parameter is used to configure a first value field of a candidate identifier allocable by the relay UE, and the first value field comprises an identifier full-value field or a subfield of the identifier full-value field;
obtaining, by the relay UE, the at least one candidate identifier based on a pre-configured second target configuration parameter; or
receiving, by the relay UE, first indication information sent by the first remote UE, and obtaining the at least one candidate identifier based on the first indication information, wherein the first indication information is used to indicate at least one identifier.
